(19) United States
(12) Patent Application Publication
(10) Pub. No.: US 2016/0177555 A1
(43) Pub. Date: Jun. 23, 2016

(54) Collapsible-Squeezable Hygienic Bottle

(71) Applicant: Nisreen Ahmed Yousif, Round Rock, TX (US)

(72) Inventor: Nisreen Ahmed Yousif, Round Rock, TX (US)

(21) Appl. No.: 14/573,675

(22) Filed: Dec. 17, 2014

(51) Int. Cl. E03D 9/08; B05B 11/04

(52) U.S. Cl. CPC E03D 9/085; B05B 11/048

(57) ABSTRACT

Disclosed herein is a hygienic bottle, which may be collapsed into a compact and portable form, which may be filled with fluid through a removable nozzle, which prevents leakage during transportation, and which is squeezable, thereby enabling a user to transport water from a location where water is available to a location where water is unavailable and use that water for washing. The most preferred embodiment is a collapsible and squeezable hygienic bottle, which comprises a bellow-shaped body with a removable nozzle distending from the top. When not in use, the bellow-shaped body collapses into a flattened shape, forming a compact package that may be easily stored in a purse or pocket. After removing the nozzle, filling the device, and replacing the nozzle, the bellow of the device is squeezed to create a pressurized stream for washing. After washing, the device is collapsed again for storage until the next use.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention is in the technical field of containers. More particularly, the preferred embodiments of the present invention relate generally to containers for transporting fluids or semi-fluids. More particularly, the preferred embodiments of the present invention relate generally to hygienic bottles. More particularly, the preferred embodiments of the present invention relate generally to collapsible hygienic bottles. More particularly, the preferred embodiments of the present invention relate generally to collapsible and squeezable hygienic bottles.

2. Description of the Related Art

The broad concept of collapsible containers is known. Often, collapsibility is used to improve the portability of these containers; however the means of collapsibility usually foreclose other useful functions and improvements, such as squeezability, etc.

It is also known to use squeezable containers. However, these squeezable containers are rarely collapsible, or are not collapsible in a well-controlled manner, and they are not easily directed to target areas of interest. Squeezability is usually used to facilitate drinking from the container, and the known squeezable containers do not provide pressures sufficient to perform some types of washing functions.

It is also known to use hygienic bottles. However, these inventions are mainly of two types: large size hygienic bottles, which usually involve applying heated or cooled water, and smaller scale hygienic bottles, such as feminine hygiene bottles. The large size hygienic bottles are not prone to portability and are intended to be used at home or in a facility, such as hospital. When used for washing, these large size hygienic bottles do not provide pressure sufficient to perform some types of washing functions. The smaller scale hygienic bottles are problematic because their small size prevents them from being filled with an adequate amount of water to perform some types of washing functions. In addition, their nozzles are very small, which makes the process of refilling difficult. These smaller scale hygienic bottles are intended for one-time use and lack the durability to allow for reuse. Additionally, they are usually not collapsible and often pre-filled with liquid, which makes them heavy and hard to transport in a pocket or purse. In addition, feminine bottles, or douche bottles, are not well suited for male use.

It is also known to use accordion-like shapes to facilitate the collapse of a container. However, these inventions usually use the accordion shape only for collapsibility and are not adopted to increase the pressure of fluid being expelled from the container or direct its flow.

It is also known to use a device to aid in religious services. However, these inventions do not provide a means to perform ritual washing.

### SUMMARY OF THE INVENTION

In Islamic religion, it is obligatory for practitioners of the faith to perform several types of ritual washings. One of them is istinja', which is performed by pouring clean water on an eliminatory outlet to purify it from traces of urine or feces even after wiping the eliminatory outlet with toilet paper or any other materials. Although American public bathrooms usually have washing areas with sinks that provide clean water, these washing areas are not often in the immediate vicinity of a toilet, especially if the toilets are in private stalls. The lack of adequate access to clean water inside toilet stalls in American restrooms creates a problem for Muslims who need to wash themselves ritually every time they use the restroom. The present invention offers a solution to this problem. The Collapsible-Squeezable Hygienic Bottle invention is a collapsible container for transporting water from a sink into a bathroom or toilet stall, which lacks adequate access to clean water in the immediate vicinity of the toilet. When collapsed, the present invention is highly portable and has a sufficiently small size, so that it can easily fit in someone's pocket or purse. When filled, the Collapsible-Squeezable Hygienic Bottle is large enough to hold enough water to perform the purifying ritual. After filling, when squeezed, the present invention has the ability to squirt water with sufficient pressure to help in performing the istinja' process in the proper areas. Although primarily used to make istinja', this use is not intended to limit the scope of the present invention, and broader applicability will be appreciated by those skilled in the art, including the performance of other ritual washing.

The broad embodiments of the present invention relate generally to a hygienic bottle, which may be collapsed into a compact and easily portable form, which may be filled with fluid through a removable nozzle, which prevents leakage during transportation, and which is squeezable, thereby enabling a user to transport water from a location where water is available to a location where water is unavailable and use that water for washing.

In one preferred embodiment, the present invention relates generally to a hygienic bottle, which comprises a flattened rounded-rectangular-shaped central body with rounded-rectangular-shaped sides that distend accordion-like on opposite sides of the central body, and a removable nozzle, which distends from the top of the central body. When not in use, the sides collapse telescopically into the central body forming a compact package that may be easily stored in a purse or pocket. To fill the device, the nozzle is removed from the central body, allowing water to enter the rounded-rectangular-shaped central body and expand the accordion-shaped bladders until the device is full. The nozzle is then replaced to allow for leak-proof transportation to a location in which a water source is not readily available. To use the device for washing, the device is squeezed to allow for a pressurized stream for washing. After washing, the device is collapsed again for storage until the next usage.

In another preferred embodiment, the present invention relates generally to a hygienic bottle, which comprises a flattened rounded-rectangular-shaped central body with ellipse-shaped sides that distend accordion-like on opposite sides of the central body, and a removable nozzle, which distends from the top of the central body. Similar to the previous embodiment, when not in use, the sides collapse accordion-like into the central body forming a compact package that may be easily stored in a purse or pocket. The compact form is held in place by a restraining strap.To fill the device, the nozzle is removed from the central body, allowing water to enter the rounded-rectangular-shaped central body and expand the accordion-shaped bladders until the device is full. The nozzle is then replaced to allow for leak-proof transportation to a location in which a water source is not readily available. To use the device for washing, the device is squeezed to allow for a pressurized stream for washing. After washing, the device is collapsed again for storage until the next usage.

In the most preferred embodiments, the present invention relates generally to a collapsible and squeezable apparatus for performing hygienic functions, which comprises a bellow-shaped body with a removable nozzle distending from the top of the bellow-shaped body. When not in use, the bellow-shaped body collapses into a flattened shape, forming a compact package that may be easily stored in a purse or pocket. To fill the device, the nozzle is removed from the bellow-shaped body, allowing water to enter the bellow-shaped body and expand the bellow until the device is full. The nozzle is then replaced to allow for leak-proof transportation to a location in which a water source is not readily available. To use the device for washing, the bellow of the device is squeezed to allow for a pressurized stream for washing. After washing, the device is collapsed again for storage until the next usage.

In sum, the Collapsible-Squeezable Hygienic Bottle invention provides a convenient means to transport clean water for washing from a location where clean water is available to a location without immediate access to clean water.

### BRIEF DESCRIPTION OF THE DRAWING

Illustrative and preferred embodiments of the present invention are shown in the accompanying drawings in which:

FIG. 1 is a perspective view of the most preferred embodiment of the present invention in the deployed configuration;

FIG. 2 is a front view of an apparatus of FIG. 1 in a deployed configuration;

FIG. 3 is a side view of an apparatus of FIG. 1 in a deployed configuration;

FIG. 4 is a top view of an apparatus of FIG. 1 in a deployed configuration;

FIG. 5 is a bottom view of an apparatus of FIG. 1 in a deployed configuration;

FIG. 6 is a perspective view of an apparatus of FIG. 1 in a collapsed configuration;

FIG. 7 is a front view of an apparatus of FIG. 1 in a collapsed configuration;

FIG. 8 is a side view of an apparatus of FIG. 1 in a collapsed configuration;

FIG. 9 is a top view of an apparatus of FIG. 1 in a collapsed configuration;

FIG. 10 is a bottom view of an apparatus of FIG. 1 in a collapsed configuration;

FIG. 11 is an exploded view of an apparatus of FIG. 1;

FIG. 12 is a perspective view of another preferred embodiment of the present invention in the deployed configuration;

FIG. 13 is a front view of an apparatus of FIG. 12 in a deployed configuration;

FIG. 14 is a side view of an apparatus of FIG. 12 in a deployed configuration;

FIG. 15 is a top view of an apparatus of FIG. 12 in a deployed configuration;

FIG. 16 is a bottom view of an apparatus of FIG. 12 in a deployed configuration;

FIG. 17 is a perspective view of an apparatus of FIG. 12 in a collapsed configuration;

FIG. 18 is a front view of an apparatus of FIG. 12 in a collapsed configuration;

FIG. 19 is a side view of an apparatus of FIG. 12 in a collapsed configuration;

FIG. 20 is a top view of an apparatus of FIG. 12 in a collapsed configuration;

FIG. 21 is a bottom view of an apparatus of FIG. 12 in a collapsed configuration;

FIG. 22 is an exploded view of an apparatus of FIG. 12;

FIG. 23 is a perspective view of another preferred embodiment of the present invention in the deployed configuration;

FIG. 24 is a front view of an apparatus of FIG. 23 in a deployed configuration;

FIG. 25 is a side view of an apparatus of FIG. 23 in a deployed configuration;

FIG. 26 is a top view of an apparatus of FIG. 23 in a deployed configuration;

FIG. 27 is a bottom view of an apparatus of FIG. 23 in a deployed configuration;

FIG. 28 is a perspective view of an apparatus of FIG. 23 in a collapsed configuration;

FIG. 29 is a front view of an apparatus of FIG. 23 in a collapsed configuration;

FIG. 30 is a side view of an apparatus of FIG. 23 in a collapsed configuration;

FIG. 31 is a top view of an apparatus of FIG. 23 in a collapsed configuration;

FIG. 32 is a bottom view of an apparatus of FIG. 23 in a collapsed configuration; and

FIG. 33 is an exploded view of an apparatus of FIG. 23.

### DETAILED DESCRIPTION OF THE PREFERRED EMBODIMENTS

For the purpose of illustration, the present invention is shown in the preferred embodiments of collapsible and squeezable apparatuses for performing hygienic functions, which comprises a closable nozzle and a collapsible leak-resistant liquid container comprising an opening for receiving the closable nozzle and a support frame. These embodiments are not intended to limit the scope of the present invention.

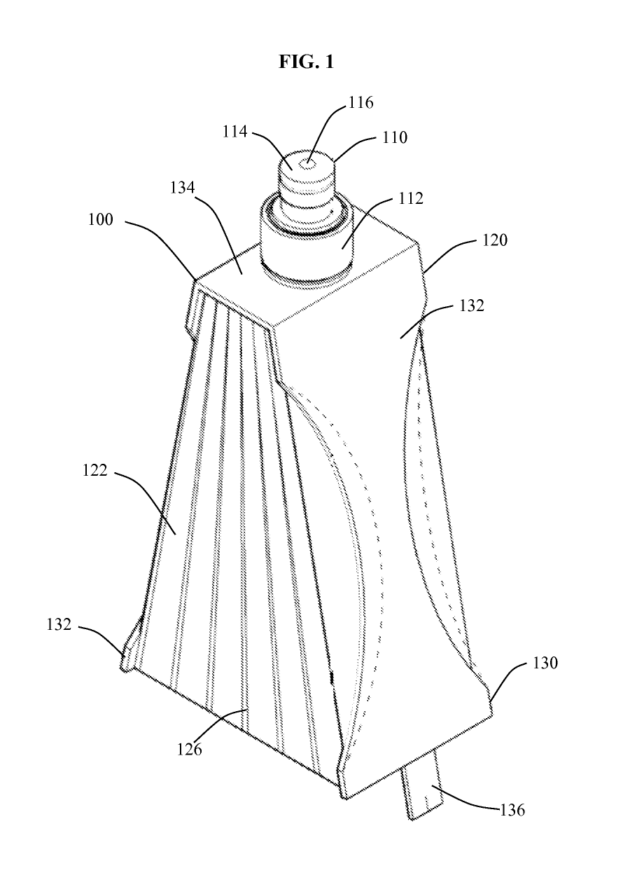

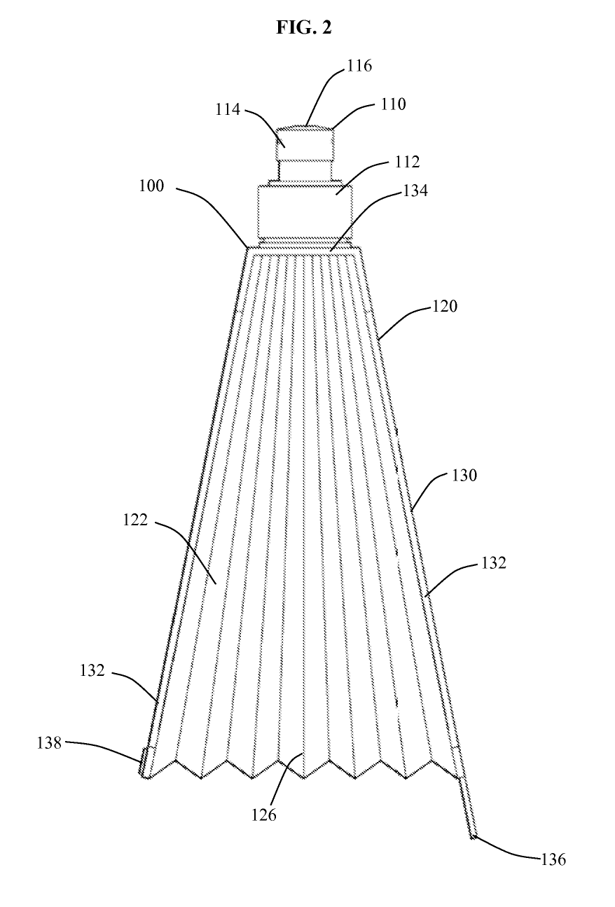

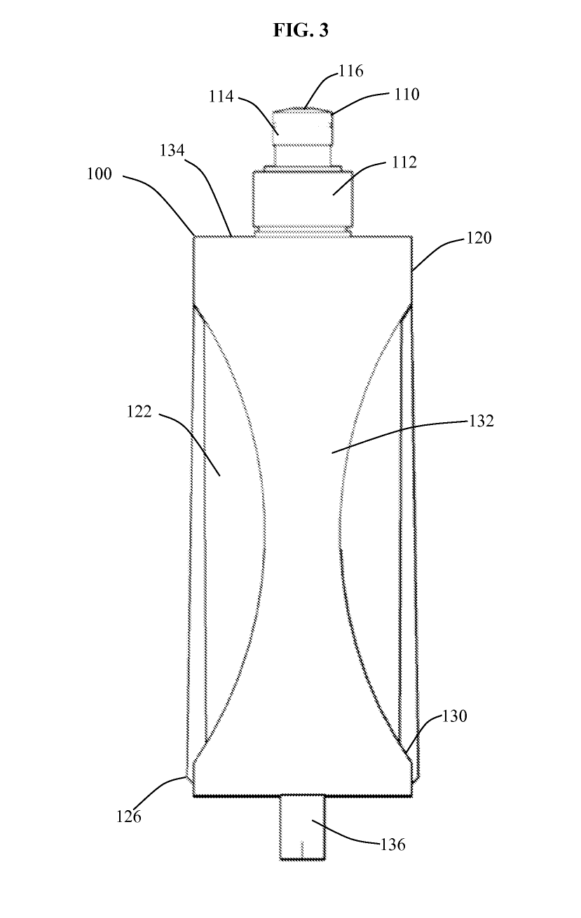

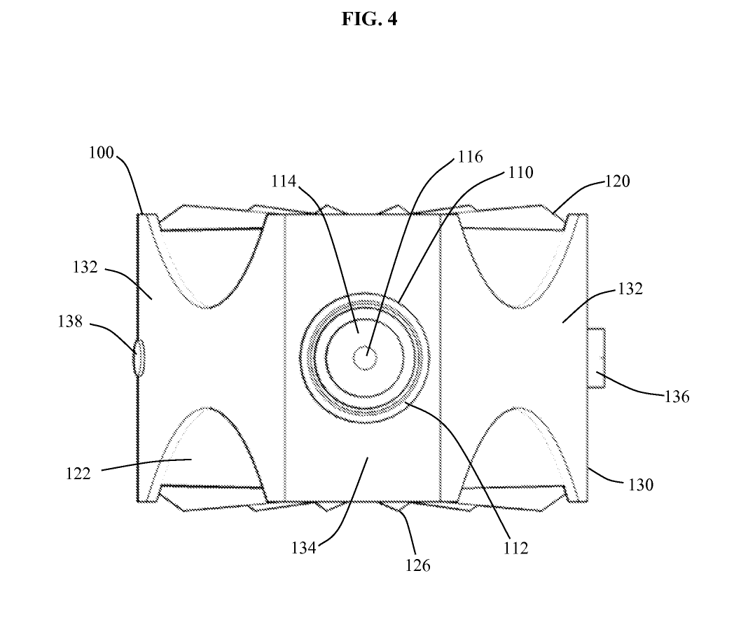

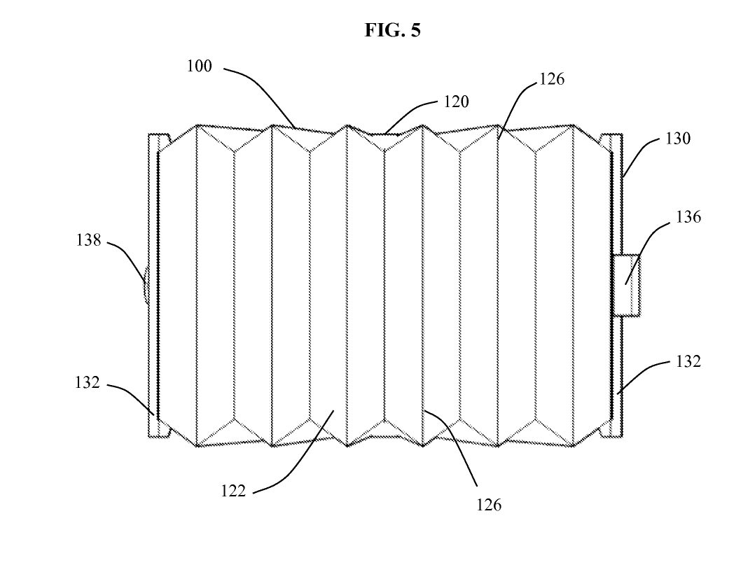

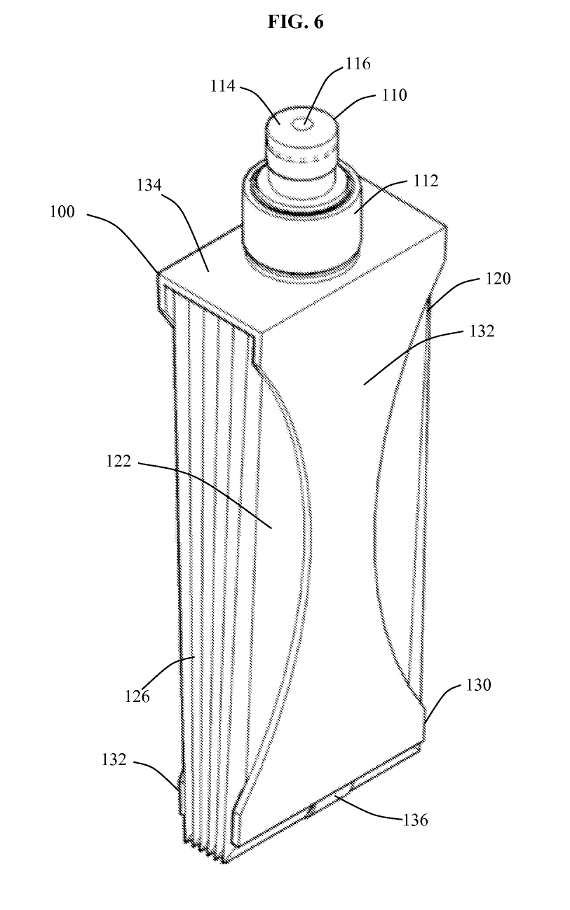

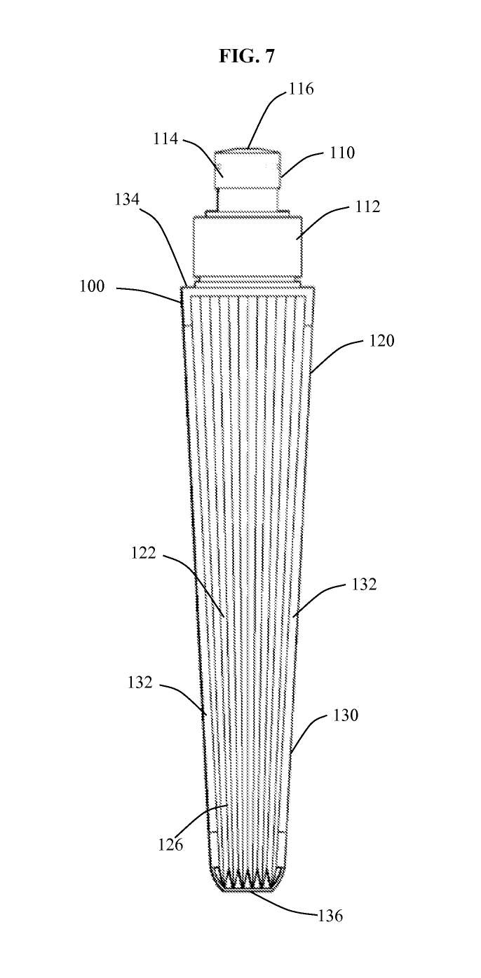

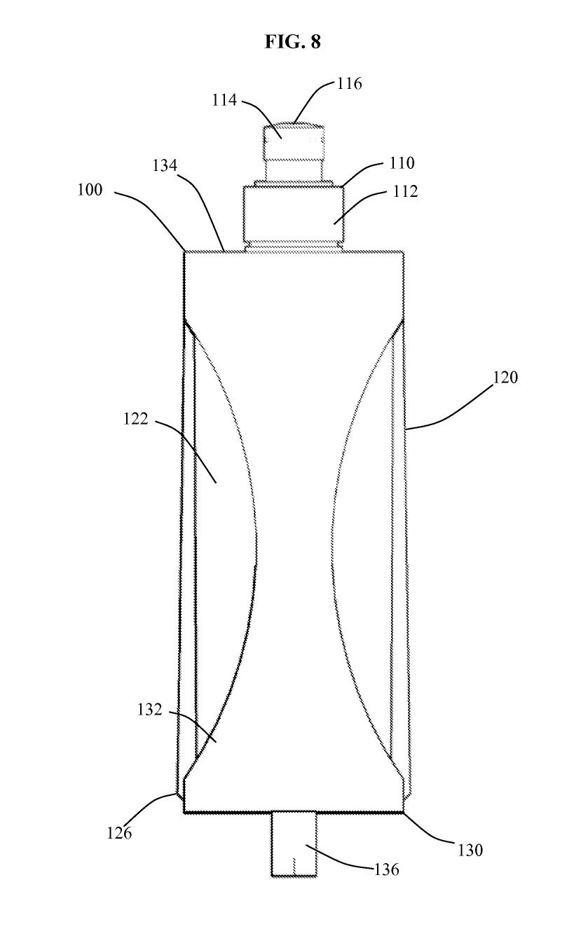

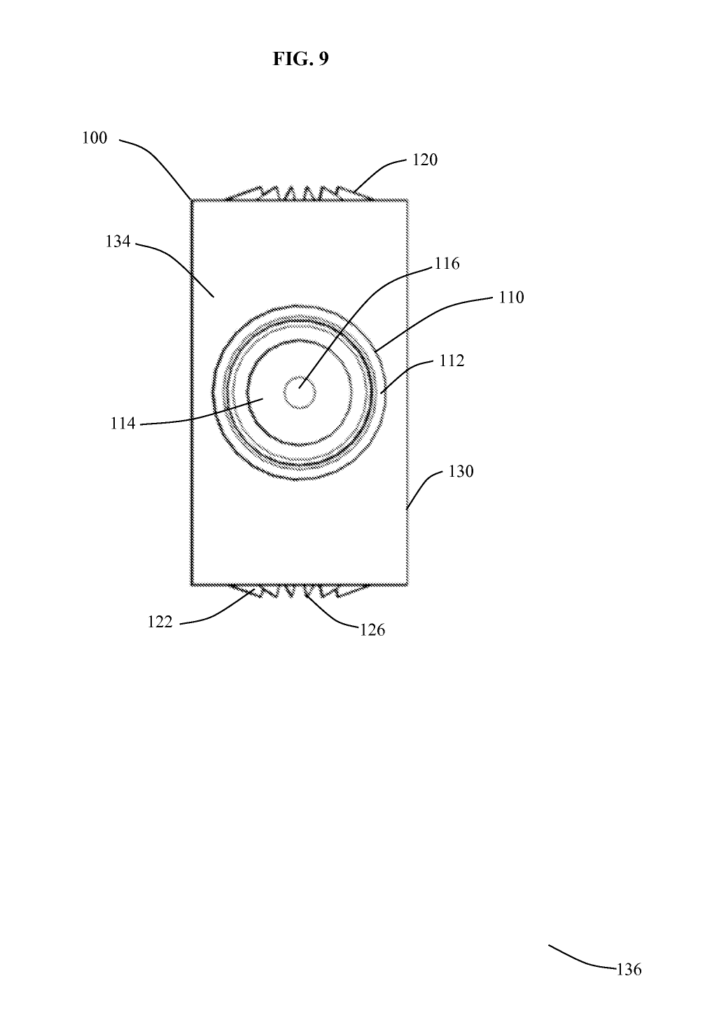

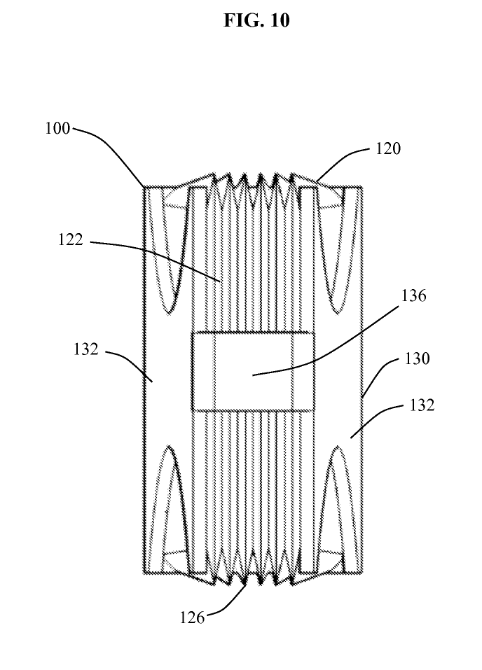

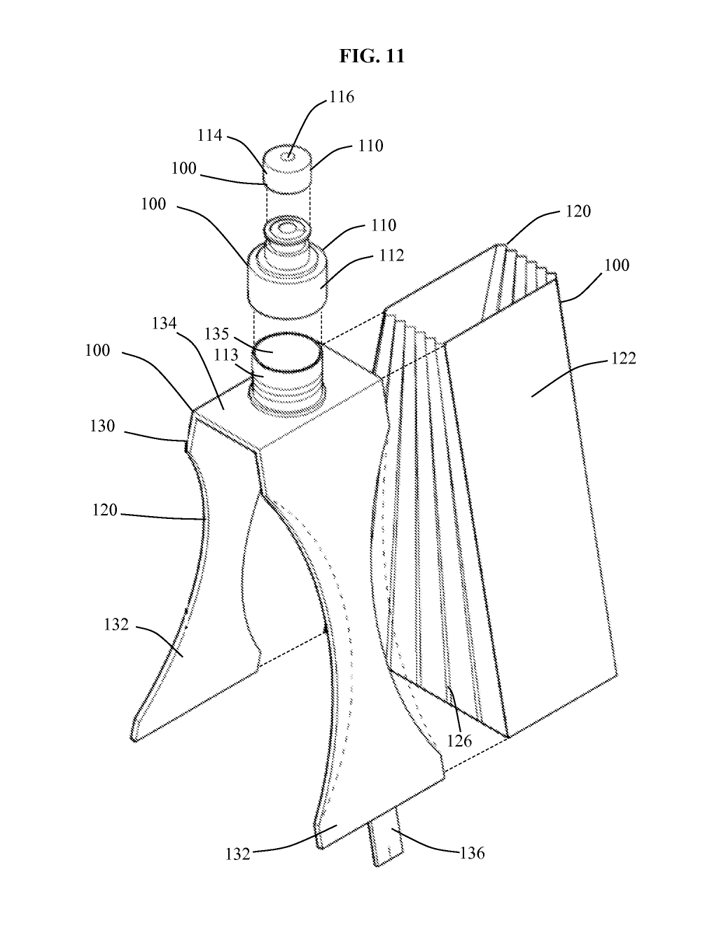

Referring now to the most preferred embodiment of the present invention, in FIG. 1, FIG. 2, FIG. 3, FIG. 4, FIG. 5, FIG. 6, FIG. 7, FIG. 8, FIG. 9, FIG. 10 and FIG. 11, a Collapsible-squeezable Hygienic Bottle 100 is shown. FIG. 1 illustrates a perspective view of a Collapsible-Squeezable Hygienic Bottle 100 in the deployed configuration. FIG. 2 depicts a front view of a Collapsible-Squeezable Hygienic Bottle 100 of FIG. 1 in a deployed configuration. FIG. 3 shows a side view of a Collapsible-Squeezable Hygienic Bottle 100 of FIG. 1 in a deployed configuration. FIG. 4 displays a top view of a Collapsible-Squeezable Hygienic Bottle 100 of FIG. 1 in a deployed configuration. FIG. 5 shows a bottom view of a Collapsible-Squeezable Hygienic Bottle 100 of FIG. 1 in a deployed configuration. FIG. 6 depicts a perspective view of a Collapsible-Squeezable Hygienic Bottle 100 of FIG. 1 in a collapsed configuration. FIG. 7 illustrates a front view of a Collapsible-Squeezable Hygienic Bottle 100 of FIG. 1 in a collapsed configuration. FIG. 8 demonstrates a side view of a Collapsible-Squeezable Hygienic Bottle 100 of FIG. 1 in a collapsed configuration. FIG. 9 shows a top view of a Collapsible-Squeezable Hygienic Bottle 100 of FIG. 1 in a collapsed configuration. FIG. 10 displays a bottom view of a Collapsible-Squeezable Hygienic Bottle 100 of FIG. 1 in a collapsed configuration. FIG. 11 depicts an exploded view of a Collapsible-Squeezable Hygienic Bottle 100 of FIG. 1.

Referring still to the most preferred embodiment of the present invention, in FIG. 1, FIG. 2, FIG. 3, FIG. 4, FIG. 5, FIG. 6, FIG. 7, FIG. 8, FIG. 9, FIG. 10 and FIG. 11, a Collapsible-Squeezable Hygienic Bottle 100 comprises a closable nozzle 110 and a collapsible container 120. The closable nozzle 110 comprises threaded body 112 and a head 114, which further comprises a dispensing opening 116. The collapsible container 120 comprises a support frame 130 and a fluid vessel 122, which are attached to each other in a sealed and leak-proof fashion. The support frame 130 comprises a frame top 134 and two frame sides 132, which distend from either end of the frame top 134. The frame top 134 comprises a threaded neck 113, which distends from the frame top 134 and which receives the threaded body 112 of the closable nozzle 110 in a leak-proof fashion. The threaded neck 113 further comprises a neck opening 135 for transferring fluid from the fluid vessel 122 to the closable nozzle 110 when the Collapsible-Squeezable Hygienic Bottle 100 is squeezed. The frames sides 132 further comprise a latch 136 and a clasp 138, which are attached on opposing frame sides 132 and which operate to hold the fluid vessel 122 in a compact manner while the Collapsible-Squeezable Hygienic Bottle 100 is in the collapsed configuration. The fluid vessel 122 further comprises a plurality of bellow folds 126, which collapses into a compact form when the Collapsible-Squeezable Hygienic Bottle 100 is in the collapsed configuration.

In further detail, referring now to FIG. 1, FIG. 2, FIG. 3, FIG. 4, and FIG. 5, a Collapsible-Squeezable Hygienic Bottle 100 is shown in a deployed configuration. In order to use the apparatus of the present invention, a Collapsible-Squeezable Hygienic Bottle 100 must be filled with hygienic fluid, such as clean water. To fill a Collapsible-Squeezable Hygienic Bottle 100, the closable nozzle 110 is removed from the collapsible container 120 and the latch 136 is disconnected from the clasp 138. Hygienic fluid is then added to the collapsible container 120 through the neck opening 135 causing the fluid vessel 122 to expand and opening the plurality of bellow folds 126 until the fluid vessel 122 is filled. Next, the closable nozzle 110 is replaced onto the threaded neck 113 where it may be locked for leak-proof transport of the apparatus by pressing the head 114 down onto the threaded body 112 of the closable nozzle 110, thereby closing the dispensing opening 116. Once the fluid vessel 122 is filled and fully expanded and the closable nozzle 110 is in place, a Collapsible-Squeezable Hygienic Bottle 100 is in the deployed configuration. Once the apparatus in the deployed configuration is transported to the appropriate locale, such as a private bathroom stall, a Collapsible-Squeezable Hygienic Bottle 100 may be used for hygienic purposes by opening the closable nozzle 110 by pulling the head 114 away from the threaded body 112, thereby opening the dispensing opening 116, and then squeezing and pressing together the frame sides 132 of the collapsible container 120, thereby forcing the hygienic fluid within to be dispensed through the dispensing opening 116 of the closable nozzle 110. A Collapsible-Squeezable Hygienic Bottle 100 is more suitable for hygienic purposes than an ordinary drinking bottle because it is substantially more suited for being squeezed than an ordinary drinking bottle, and the additional pressure caused by its improved squeezability expels hygienic fluid more forcefully than an ordinary drinking bottle would dispense water, thereby better facilitating hygienic functions, such as washing.

In further detail, referring now to FIG. 6, FIG. 7, FIG. 8, FIG. 9 and FIG. 10, a Collapsible-Squeezable Hygienic Bottle 100 is shown in a collapsed configuration. Before and after using a Collapsible-Squeezable Hygienic Bottle 100 for hygienic purposes, a Collapsible-Squeezable Hygienic Bottle 100 may be easily transported in a compact form so that it may be available when a user requires hygienic activity but encounter facilities that do not provide adequate access to hygienic fluid in the exact locale where the hygienic activity will occur. In order to transport a Collapsible-Squeezable Hygienic Bottle 100 in a compact manner, a Collapsible-Squeezable Hygienic Bottle 100 may be set in a collapsed configuration by emptying the collapsible container 120 and collapsing the plurality of bellow folds 126 by bringing the frame sides 132 together, connecting the latch 136 to the clasp 138, and closing the closable nozzle 110 by pressing the head 114 down onto the threaded body 112 of the closable nozzle 110, thereby closing the dispensing opening 116. Once in the collapsed configuration, a Collapsible-Squeezable Hygienic Bottle 100 may be easily transported in a purse or pocket in a leak-proof manner.

The construction details of the invention as shown in FIG. 1, FIG. 2, FIG. 3, FIG. 4, FIG. 5, FIG. 6, FIG. 7, FIG. 8, FIG. 9, FIG. 10 and FIG. 11, are as follows. The threaded body 112 of the closable nozzle 110 is a singular construction, which comprises a rigid material, such as plastic, polypropylene, silicone, composite material, or the like. The head 114 of the closable nozzle 110 is a singular construction, which comprises a rigid material such plastic, polypropylene, silicone, composite material, or the like. The support frame 130 of the collapsible container 120 is a singular construction, which comprises a semi-rigid material, such as plastic, polypropylene, silicone, composite material, or the like. The fluid vessel 122 of the collapsible container 120 is a singular construction, which comprises a flexible and foldable material, such as plastic, polypropylene, silicone, rubber, composite material, or the like. The support frame 130 and the fluid vessel 122 of the collapsible container 120 are attached to each other using a glue-like substance, such as glue, adhesive, silicone adhesive, plastic adhesive, or the like, and are sealed together in a leak-proof fashion, which can substantially withstand the pressure of being squeezed without releasing fluid through the connection. The latch 136 on the frames sides 132 comprises plastic, polypropylene, silicone, composite material, or the like. The clasp 138 on the frame sides 132 comprises plastic, polypropylene, silicone, composite material, or the like. The materials listed herein are examples only and not intended to limit the scope of the present invention.

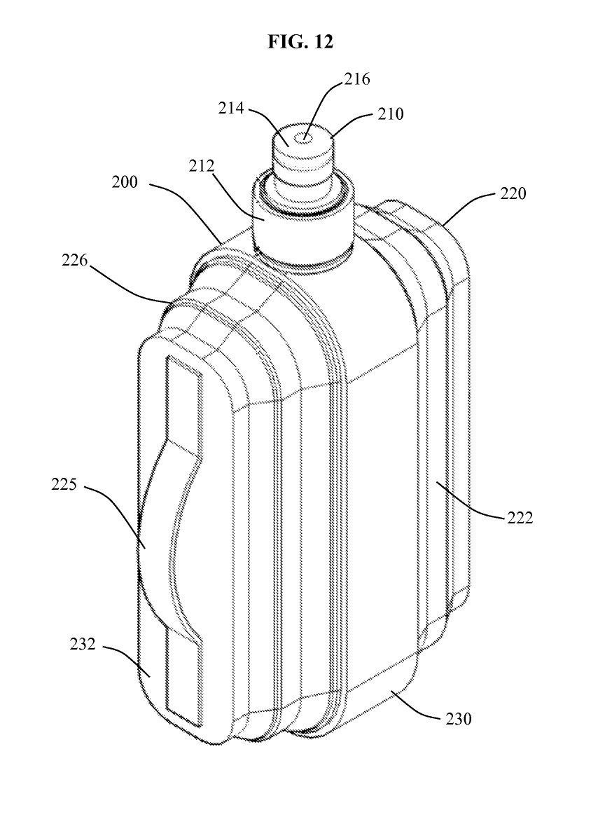

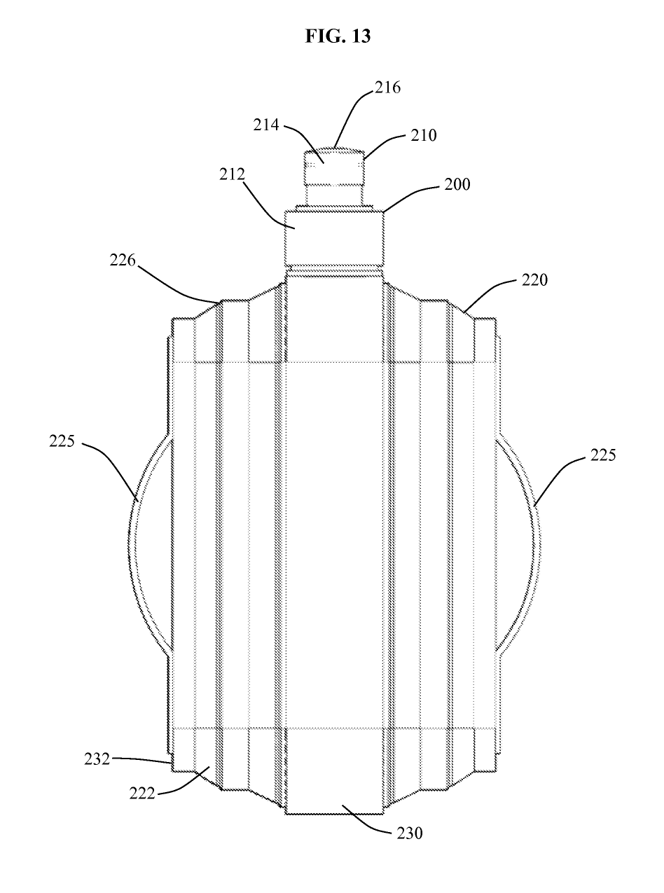

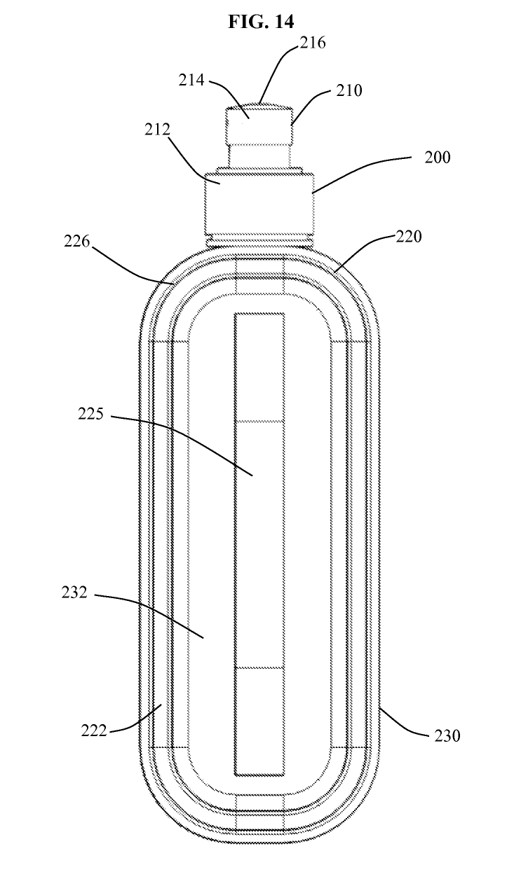

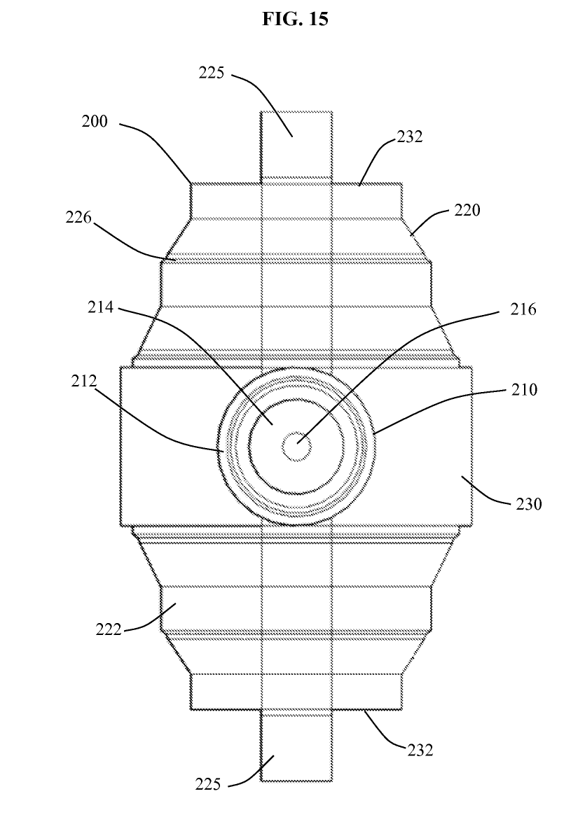

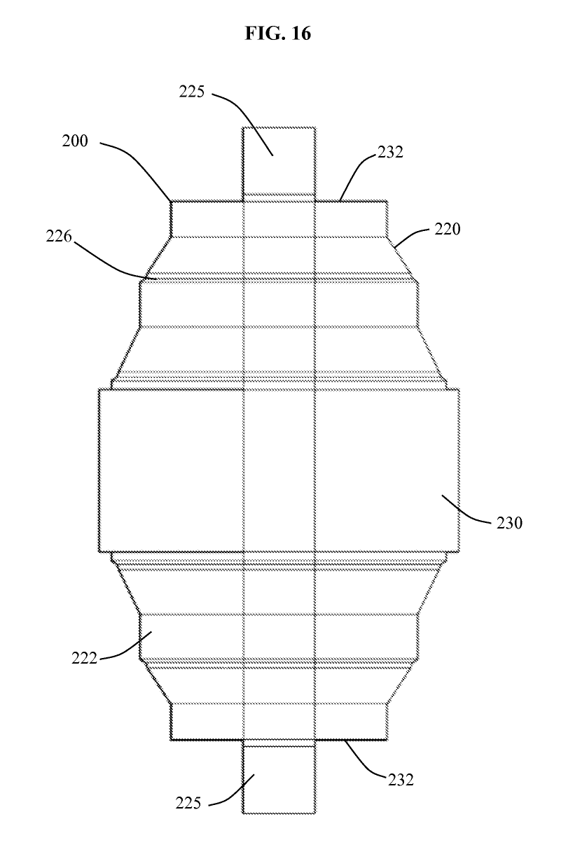

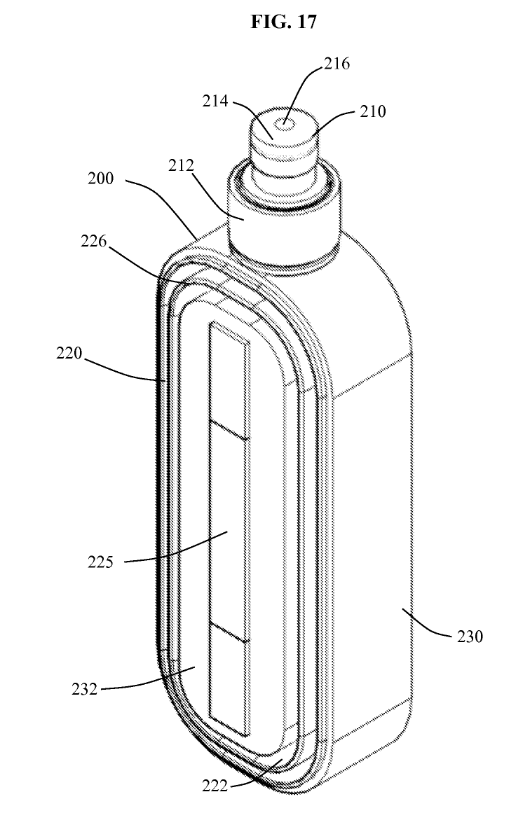

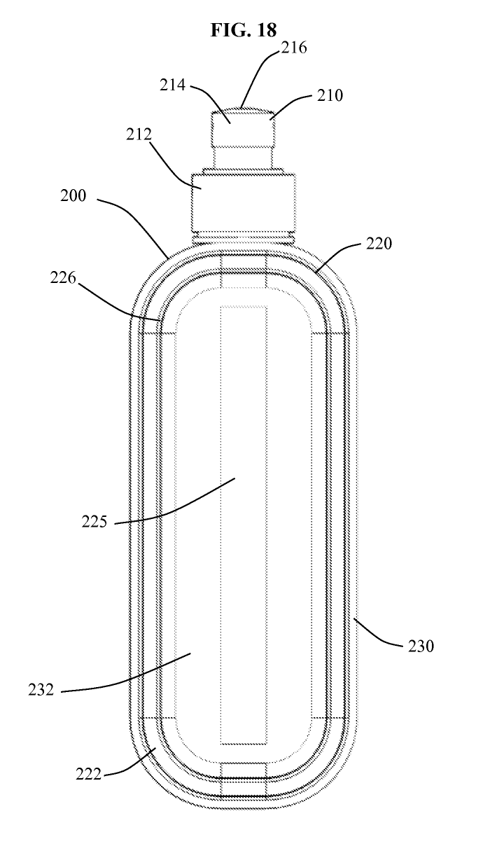

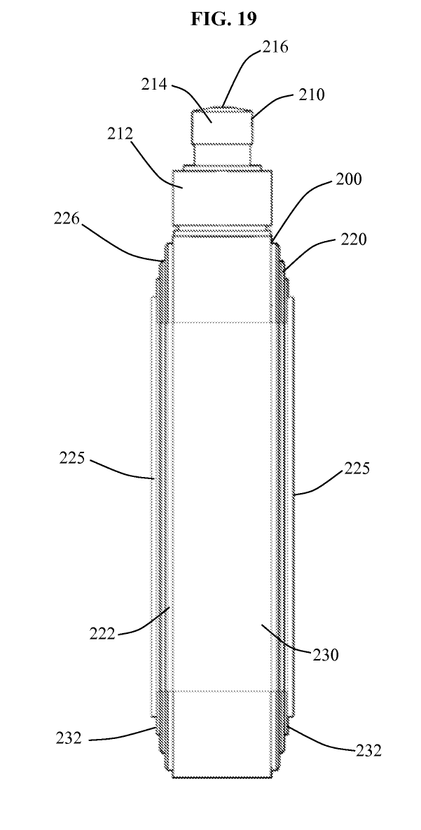

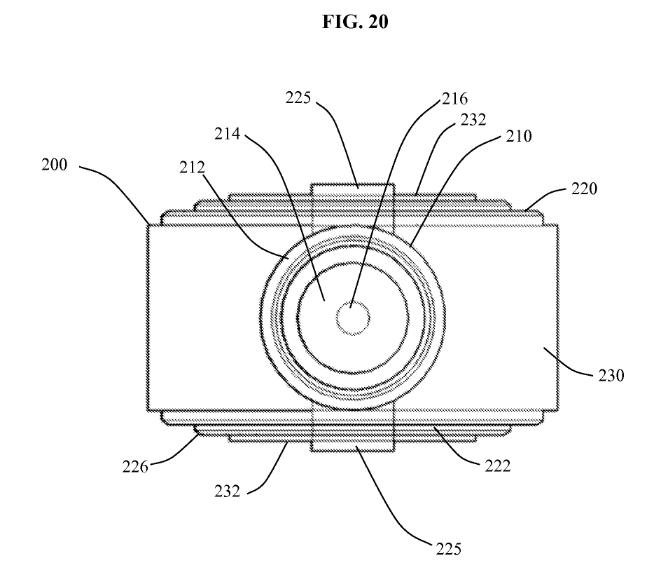

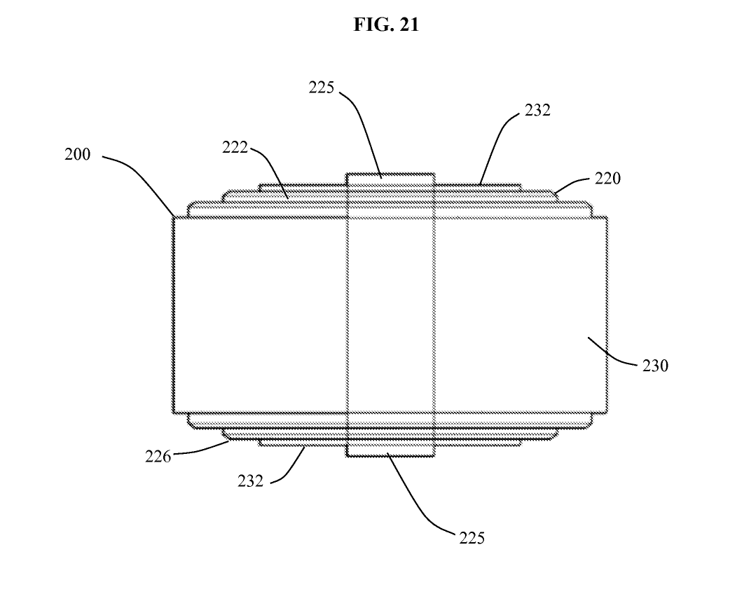

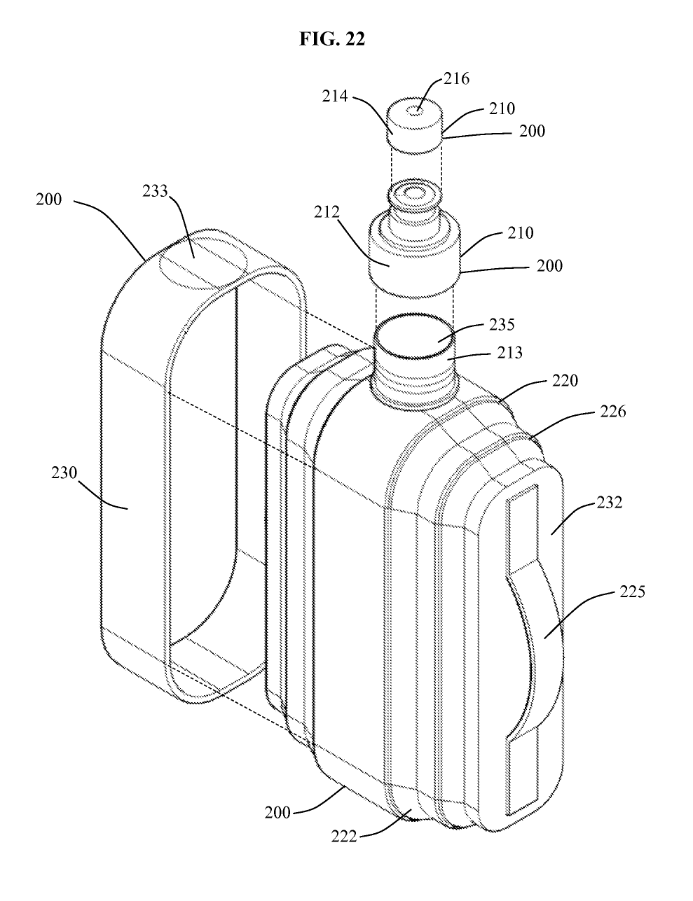

Referring now to another preferred embodiment of the present invention, in FIG. 12, FIG. 13, FIG. 14, FIG. 15, FIG. 16, FIG. 17, FIG. 18, FIG. 19, FIG. 20, FIG. 21 and FIG. 22, a Collapsible-Squeezable Hygienic Bottle 200 is shown. FIG. 12 illustrates a perspective view of a Collapsible-Squeezable Hygienic Bottle 200 in the deployed configuration. FIG. 13 depicts a front view of a Collapsible-Squeezable Hygienic Bottle 200 of FIG. 12 in a deployed configuration. FIG. 14 shows a side view of a Collapsible-Squeezable Hygienic Bottle 200 of FIG. 12 in a deployed configuration. FIG. 15 displays a top view of a Collapsible-Squeezable Hygienic Bottle 200 of FIG. 12 in a deployed configuration. FIG. 16 shows a bottom view of a Collapsible-Squeezable Hygienic Bottle 200 of FIG. 12 in a deployed configuration. FIG. 17 depicts a perspective view of a Collapsible-Squeezable Hygienic Bottle 200 of FIG. 12 in a collapsed configuration. FIG. 18 illustrates a front view of a Collapsible-Squeezable Hygienic Bottle 200 of FIG. 12 in a collapsed configuration. FIG. 19 demonstrates a side view of a Collapsible-Squeezable Hygienic Bottle 200 of FIG. 12 in a collapsed configuration. FIG. 20 shows a top view of a Collapsible-Squeezable Hygienic Bottle 200 of FIG. 12 in a collapsed configuration. FIG. 21 displays a bottom view of a Collapsible-Squeezable Hygienic Bottle 200 of FIG. 12 in a collapsed configuration. FIG. 22 depicts an exploded view of a Collapsible-Squeezable Hygienic Bottle 200 of FIG. 12.

Referring still to the invention of FIG. 12, FIG. 13, FIG. 14, FIG. 15, FIG. 16, FIG. 17, FIG. 18, FIG. 19, FIG. 20, FIG. 21 and FIG. 22, a Collapsible-Squeezable Hygienic Bottle 200 comprises a closable nozzle 210, a body 220, and a support frame 230. The closable nozzle 210 comprises a threaded body 212 and a head 214, which further comprises a dispensing opening 216. The body 220 comprises a collapsible container 222 and a threaded neck 213, which distends from the top of the collapsible container 222 and which receives the threaded body 212 of the closable nozzle 210 in a leak-proof fashion. The collapsible container 222 further comprises side panels 232, handles 225 that distend from the side panels 232, and a plurality of collapsing folds 226, which allow the collapsible container 222 to collapse into a compact form by bringing the side panels 232 together. The threaded neck 213 further comprises a neck opening 235 for transferring fluid from the collapsible container 222 to the closable nozzle 210 when the Collapsible-Squeezable Hygienic Bottle 200 is squeezed. The support frame 230 comprises a rounded rectangular frame that fits over the collapsible container 222 with a top opening 233, which allows the threaded neck 213 to distend through it when the support frame 230 is fitted over the collapsible container 222.

In further detail, referring now to FIG. 12, FIG. 13, FIG. 14, FIG. 15 and FIG. 16, a Collapsible-Squeezable Hygienic Bottle 200 is shown in a deployed configuration. In order to use the apparatus of the present invention, a Collapsible-Squeezable Hygienic Bottle 200 must be filled with hygienic fluid, such as clean water. To fill a Collapsible-Squeezable Hygienic Bottle 200, the closable nozzle 210 is removed from the threaded neck 213 of the body 220. Hygienic fluid is then added to the collapsible container 222 through the neck opening 235 causing the collapsible container 222 to expand and unfolding the plurality of collapsing folds 226 until the collapsible container 222 is filled. Next, the closable nozzle 210 is replaced onto the threaded neck 213 where it may be locked for leak-proof transport of the apparatus by pressing the head 214 down onto the threaded body 212 of the closable nozzle 210, thereby closing the dispensing opening 216. Once the collapsible container 222 is filled and fully expanded and the closable nozzle 210 is in place, a Collapsible-Squeezable Hygienic Bottle 200 is in the deployed configuration. Once the apparatus in the deployed configuration is transported to the appropriate locale, such as a private bathroom stall, a Collapsible-Squeezable Hygienic Bottle 200 may be used for hygienic purposes by opening the closable nozzle 210 by pulling the head 214 away from the threaded body 212, thereby opening the dispensing opening 216, and then squeezing and pressing together the sides panels 232 of the collapsible container 222, thereby forcing the hygienic fluid within to be dispensed through the dispensing opening 216 of the closable nozzle 210. A Collapsible-Squeezable Hygienic Bottle 200 is more suitable for hygienic purposes than an ordinary drinking bottle because it is substantially more suited for being squeezed than an ordinary drinking bottle, and the additional pressure caused by its improved squeezability expels hygienic fluid more forcefully than an ordinary drinking bottle would dispense water, thereby better facilitating hygienic functions, such as washing.

In further detail, referring now to FIG. 17, FIG. 18, FIG. 19, FIG. 20 and FIG. 21, a Collapsible-Squeezable Hygienic Bottle 200 is shown in a collapsed configuration. Before and after using a Collapsible-Squeezable Hygienic Bottle 200 for hygienic purposes, a Collapsible-Squeezable Hygienic Bottle 200 may be easily transported in a compact form so that it may be available when a user requires hygienic activity but encounter facilities that do not provide adequate access to hygienic fluid in the exact locale where the hygienic activity will occur. In order to transport a Collapsible-Squeezable Hygienic Bottle 200 in a compact manner, a Collapsible-Squeezable Hygienic Bottle 200 may be set in a collapsed configuration by emptying the collapsible container 222 and collapsing the plurality of collapsing folds 226 by bringing the side panels 232 of the collapsible container 222 together, and closing the closable nozzle 210 by pressing the head 214 down onto the threaded body 212 of the closable nozzle 210, thereby closing the dispensing opening 216. Once in the collapsed configuration, a Collapsible-Squeezable Hygienic Bottle 200 may be easily transported in a purse or pocket in a leak-proof manner.

The construction details of the invention as shown in FIG. 12, FIG. 13, FIG. 14, FIG. 15, FIG. 16, FIG. 17, FIG. 18, FIG. 19, FIG. 20, FIG. 21 and FIG. 22, are as follows. The threaded body 112 of the closable nozzle 110 is a singular construction, which comprises a rigid material, such as plastic, polypropylene, silicone, composite material, or the like. The head 114 of the closable nozzle 110 is a singular construction, which comprises a rigid material such plastic, polypropylene, silicone, composite material, or the like. The collapsible container 222 comprises a flexible and foldable material, such as plastic, polypropylene, silicone, rubber, composite material, or the like, which allows the collapsing folds 226 to fold together in a compact manner. The support frame 230 is a singular construction, which comprises a semi-rigid material, such as plastic, polypropylene, silicone, composite material, or the like. The threaded neck 213 of the body 220 comprises a rigid material, such as plastic, polypropylene, silicone, composite material, or the like. The handles 225 comprise a rigid material such as plastic, polypropylene, silicone, composite material, or the like. The materials listed herein are examples only and not intended to limit the scope of the present invention.

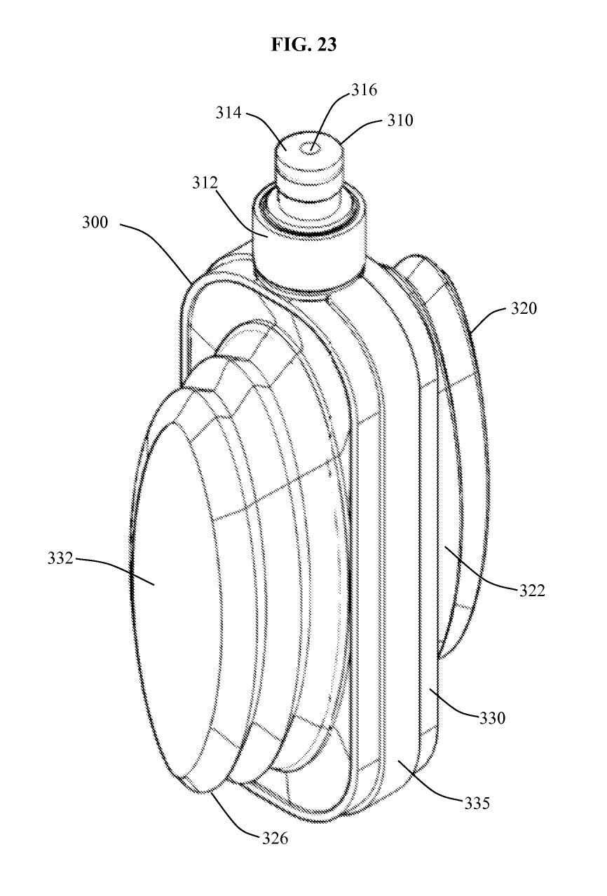

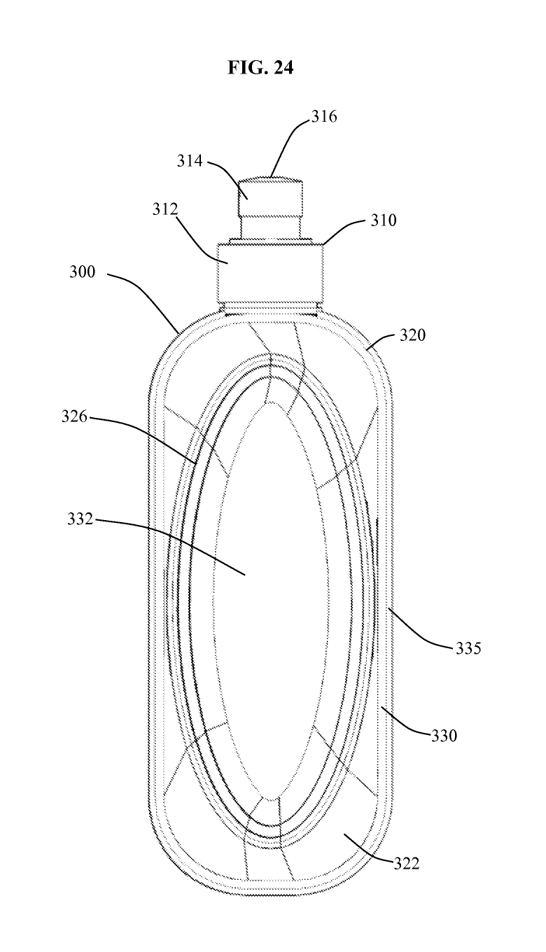

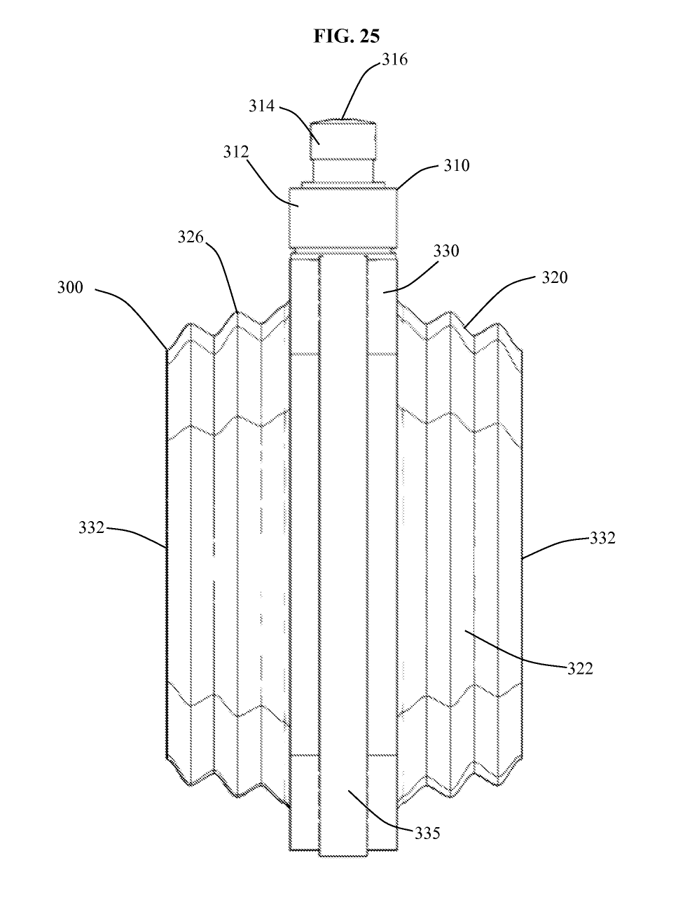

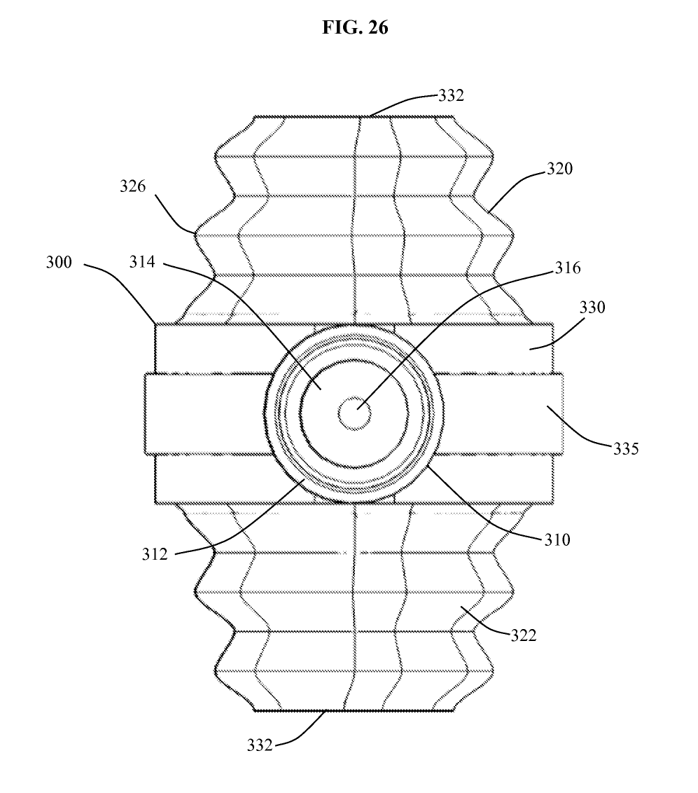

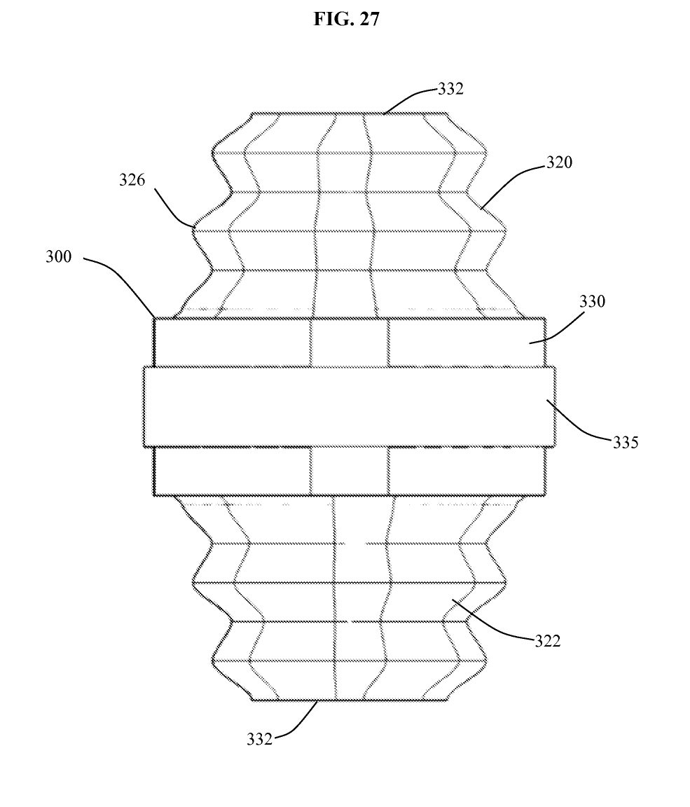

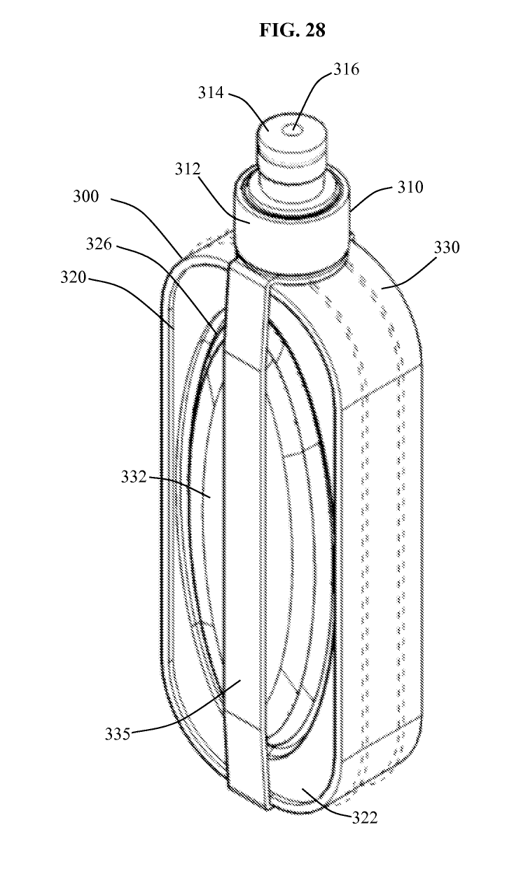

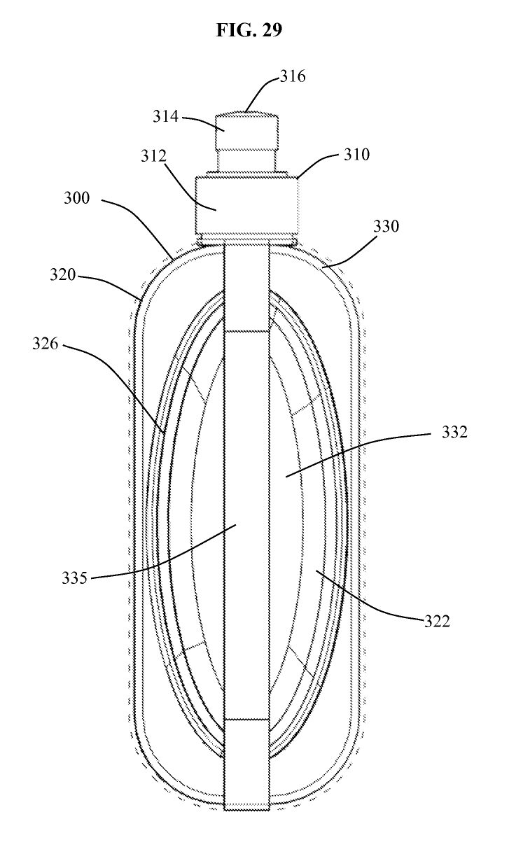

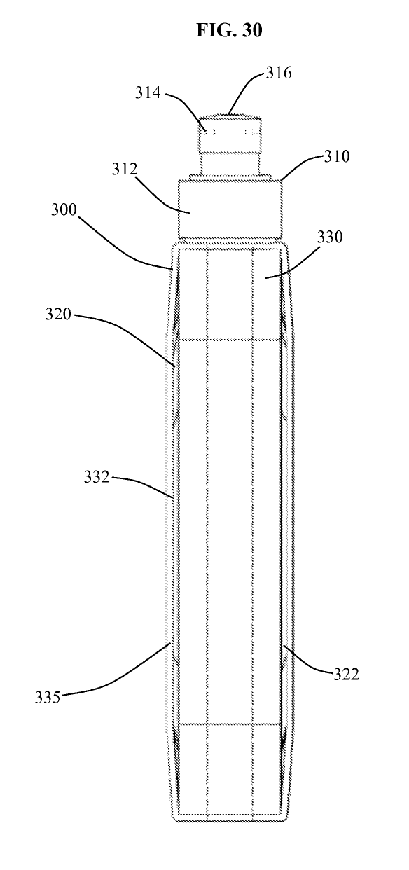

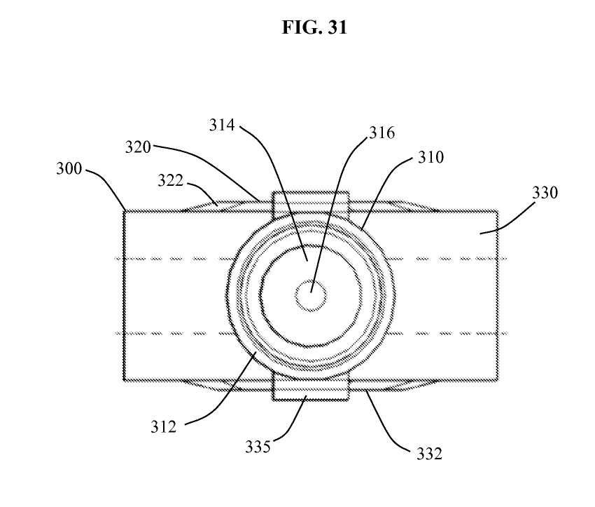

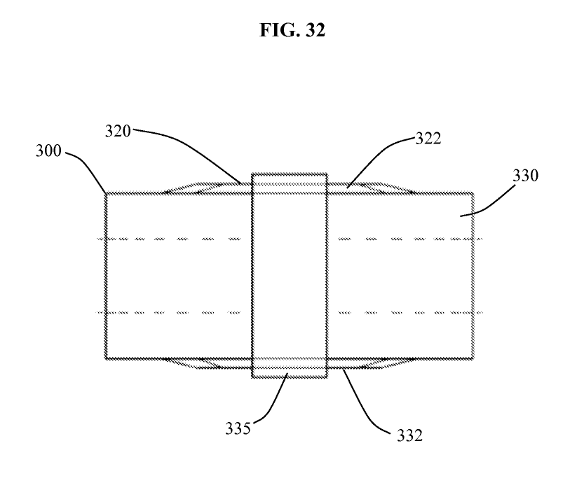

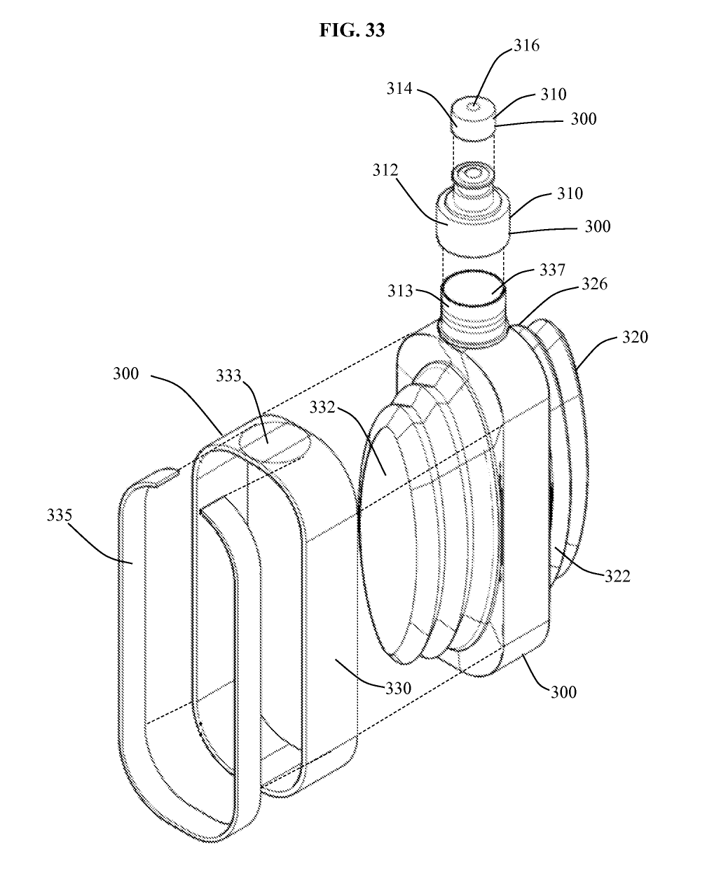

Referring now to another preferred embodiment of the present invention, in FIG. 23, FIG. 24, FIG. 25, FIG. 26, FIG. 27, FIG. 28, FIG. 29, FIG. 30, FIG. 31, FIG. 32 and FIG. 33, a Collapsible-Squeezable Hygienic Bottle 300 is shown. FIG. 23 illustrates a perspective view of a Collapsible-Squeezable Hygienic Bottle 300 in the deployed configuration. FIG. 24 depicts a front view of a Collapsible-Squeezable Hygienic Bottle 300 of FIG. 23 in a deployed configuration. FIG. 25 shows a side view of a Collapsible-Squeezable Hygienic Bottle 300 of FIG. 23 in a deployed configuration. FIG. 26 displays a top view of a Collapsible-Squeezable Hygienic Bottle 300 of FIG. 23 in a deployed configuration. FIG. 27 shows a bottom view of a Collapsible-Squeezable Hygienic Bottle 300 of FIG. 23 in a deployed configuration. FIG. 28 depicts a perspective view of a Collapsible-Squeezable Hygienic Bottle 300 of FIG. 23 in a collapsed configuration. FIG. 29 illustrates a front view of a Collapsible-Squeezable Hygienic Bottle 300 of FIG. 23 in a collapsed configuration. FIG. 30 demonstrates a side view of a Collapsible-Squeezable Hygienic Bottle 300 of FIG. 23 in a collapsed configuration. FIG. 31 shows a top view of a Collapsible-Squeezable Hygienic Bottle 300 of FIG. 23 in a collapsed configuration. FIG. 32 displays a bottom view of a Collapsible-Squeezable Hygienic Bottle 100 of FIG. 23 in a collapsed configuration. FIG. 33 depicts an exploded view of a Collapsible-Squeezable Hygienic Bottle 300 of FIG. 23.

Referring still to the invention of FIG. 23, FIG. 24, FIG. 25, FIG. 26, FIG. 27, FIG. 28, FIG. 29, FIG. 30, FIG. 31, FIG. 32 and FIG. 33, a Collapsible-Squeezable Hygienic Bottle 300 comprises a closable nozzle 310, a body 320, a support frame 230 and a restraining strap 335. The closable nozzle 310 comprises a threaded body 312 and a head 314, which further comprises a dispensing opening 316. The body 320 comprises a collapsible container 322 and a threaded neck 313, which distends from the top of the collapsible container 322 and which receives the threaded body 312 of the closable nozzle 310 in a leak-proof fashion. The collapsible container 322 further comprises side panels 332, which are ellipse-shaped, and a plurality of collapsing folds 326, which allow the collapsible container 322 to collapse into a compact form by bringing the side panels 332 together. The threaded neck 313 further comprises a neck opening 337 for transferring fluid from the collapsible container 322 to the closable nozzle 310 when the Collapsible-Squeezable Hygienic Bottle 300 is squeezed. The support frame 330 comprises a rounded rectangular frame that fits over the collapsible container 322 with a top opening 333, which allows the threaded neck 313 to distend through it when the support frame 330 is fitted over the collapsible container 322. The restraining strap 335 comprises a resilient stretchable band, which may stretch over the support frame 330 when a Collapsible-Squeezable Hygienic Bottle 300 is in the deployed configuration, as shown in FIG. 23, FIG. 24, FIG. 25, FIG. 26 and FIG. 27, and which functions to restrain the collapsible container 322 in a compact manner when a Collapsible-Squeezable Hygienic Bottle 300 is in the collapsed configuration, as shown in FIG. 28, FIG. 29, FIG. 30, FIG. 31 and FIG. 32.

In further detail, referring now to FIG. 23, FIG. 24, FIG. 25, FIG. 26 and FIG. 27, a Collapsible-Squeezable Hygienic Bottle 300 is shown in a deployed configuration with the restraining strap 335 stretched over the support frame 330. In order to use the apparatus of the present invention, a Collapsible-Squeezable Hygienic Bottle 300 must be filled with hygienic fluid, such as clean water. To fill a Collapsible-Squeezable Hygienic Bottle 300, the closable nozzle 310 is removed from the threaded neck 313 of the body 320. Hygienic fluid is then added to the collapsible container 322 through the neck opening 337 causing the collapsible container 322 to expand and unfolding the plurality of collapsing folds 326 until the collapsible container 322 is filled. Next, the closable nozzle 310 is replaced onto the threaded neck 313 where it may be locked for leak-proof transport of the apparatus by pressing the head 314 down onto the threaded body 312 of the closable nozzle 310, thereby closing the dispensing opening 316. Once the collapsible container 322 is filled and fully expanded and the closable nozzle 310 is in place, a Collapsible-Squeezable Hygienic Bottle 300 is in the deployed configuration. Once the apparatus in the deployed configuration is transported to the appropriate locale, such as a private bathroom stall, a Collapsible-Squeezable Hygienic Bottle 300 may be used for hygienic purposes by opening the closable nozzle 310 by pulling the head 314 away from the threaded body 312, thereby opening the dispensing opening 316, and then squeezing and pressing together the sides panels 332 of the collapsible container 322, thereby forcing the hygienic fluid within to be dispensed through the dispensing opening 316 of the closable nozzle 310. A Collapsible-Squeezable Hygienic Bottle 300 is more suitable for hygienic purposes than an ordinary drinking bottle because it is substantially more suited for being squeezed than an ordinary drinking bottle, and the additional pressure caused by its improved squeezability expels hygienic fluid more forcefully than an ordinary drinking bottle would dispense water, thereby better facilitating hygienic functions, such as washing.

In further detail, referring now to FIG. 28, FIG. 29, FIG. 30, FIG. 31 and FIG. 32, a Collapsible-Squeezable Hygienic Bottle 300 is shown in a collapsed configuration. Before and fter using a Collapsible-Squeezable Hygienic Bottle 300 for hygienic purposes, a Collapsible-Squeezable Hygienic Bottle 300 may be easily transported in a compact form so that it may be available when a user requires hygienic activity but encounter facilities that do not provide adequate access to hygienic fluid in the exact locale where the hygienic activity will occur. In order to transport a Collapsible-Squeezable Hygienic Bottle 300 in a compact manner, a Collapsible-Squeezable Hygienic Bottle 300 may be set in a collapsed configuration by emptying the collapsible container 322 and collapsing the plurality of collapsing folds 326 by bringing the side panels 332 of the collapsible container 322 together, and closing the closable nozzle 310 by pressing the head 314 down onto the threaded body 312 of the closable nozzle 310, thereby closing the dispensing opening 316. Next, the restraining strap 335 is removed from over the support frame 330 and rotated to a position over the center of the side panels 332 so that the collapsible container 322 is restrained in a compact and secure manner, thereby setting a Collapsible-Squeezable Hygienic Bottle 300 is in the collapsed configuration. Once in the collapsed configuration, a Collapsible-Squeezable Hygienic Bottle 300 may be easily transported in a purse or pocket in a leak-proof manner.

The construction details of the invention as shown in FIG. 23, FIG. 24, FIG. 25, FIG. 26, FIG. 27, FIG. 28, FIG. 29, FIG. 30, FIG. 31, FIG. 32 and FIG. 33, are as follows. The threaded body 312 of the closable nozzle 310 is a singular construction, which comprises a rigid material, such as plastic, polypropylene, silicone, composite material, or the like. The head 314 of the closable nozzle 310 is a singular construction, which comprises a rigid material such plastic, polypropylene, silicone, composite material, or the like. The collapsible container 322 comprises a flexible and foldable material, such as plastic, polypropylene, silicone, rubber, composite material, or the like, which allows the collapsing folds 326 to fold together in a compact manner. The support frame 330 is a singular construction, which comprises a semi-rigid material, such as plastic, polypropylene, silicone, composite material, or the like. The threaded neck 313 of the body 320 comprises a rigid material, such as plastic, polypropylene, silicone, composite material, or the like. The restraining strap 335 comprises a resilient stretchable material such as plastic, rubber, polypropylene, silicone, composite material, or the like. The materials listed herein are examples only and not intended to limit the scope of the present invention.

The advantages of the present invention include, without limitation, that it provides a convenient means to transport clean water for washing from a location where clean water is available to a location without immediate access to clean water, that it allows for the transport of water from a sink into a bathroom or toilet stall that lacks adequate access to clean water in the immediate vicinity of the toilet, that, when collapsed, it is highly portable and has a sufficiently small size to easily fit in someone's pocket or purse, that, when filled, it is large enough to hold enough water to perform the purifying ritual istinja', and that, after filling and when squeezed, it has the ability to squirt water with sufficient pressure to help in performing the process of istinja in the proper areas. In sum, the Collapsible-Squeezable Hygienic Bottle is a simple and elegant design, which is inexpensive to manufacture, and provides an affordable solution for providing clean water for washing in bathroom or toilet stalls, which lack access to clean water in their immediate vicinity.

In broad embodiment, the present invention relates generally to a hygienic bottle, which may be collapsed into a compact and easily portable form, which may be filled with fluid through a removable nozzle, which prevents leakage during transportation, and which is squeezable, thereby enabling a user to transport water from a location where water is available to a location where water is unavailable and use that water for washing.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods that are within the scope and spirit of the invention as claimed.

What is claimed is:

1. A hygienic bottle comprising:
a collapsible body, said collapsible body being sufficiently small when collapsed to be portable, said collapsible body being sufficiently large when filled to transport a sufficient amount of water for washing, and said collapsible body being squeezable when filled; and
a removable nozzle, said removable nozzle depending from said collapsible body in a removable manner;
wherein, when said collapsible body is collapsed, a user may transport said hygienic bottle in a compact manner to a location where said water is available;
wherein a user may remove said removable nozzle from said collapsible body, fill said collapsible body with said water, thereby expanding said collapsible body, and restore said removable nozzle;
wherein a user may transport said water in said hygienic bottle in a leak-proof manner from a said location where said water is available to a location where said water is unavailable; and
wherein said user may use said water for washing by expelling said water from said collapsible body in a pressurized manner by squeezing said filled collapsible body.

2. An collapsible and squeezable apparatus for performing hygienic functions, said apparatus comprising:
a closable nozzle, said closable nozzle comprising:
a threaded body, and
a head, which further comprises a dispensing opening; and
a collapsible container, said collapsible container comprising:
a fluid vessel, said fluid vessel being expandable and collapsible, said fluid vessel comprising:
a plurality of bellow folds, which collapses into a compact form when said fluid vessel is collapsed; and
a support frame, said support frame comprising:
a frame top, said frame top comprising:
a threaded neck, said threaded neck distending from said frame top, said threaded neck being capable of receiving said threaded body of said closable nozzle in a leak-proof fashion, and said threaded neck further comprising:
a neck opening for transferring fluid into said fluid vessel during filling and for expelling said fluid from said fluid vessel through said closable nozzle in a pressurized manner when said fluid vessel is filled and squeezed, and
two frame sides, which distend from either end of said frame top, said frames sides further comprising:
a latch and
a clasp,
said latch and clasp being attached on opposing said frame sides and operating to hold said fluid vessel in a compact manner when said fluid vessel is collapsed;
wherein said fluid vessel and said support frame are attached to each other in a sealed and leak-proof fashion.

3. An collapsible and squeezable apparatus for performing hygienic functions, said apparatus comprising:
a closable nozzle, said closable nozzle comprising:
a threaded body, and
a head, which further comprises a dispensing opening; and
a body, said body comprising:
a collapsible container, said collapsible container further comprising:
side panels, and
a plurality of collapsing folds, which allow said collapsible container to collapse into a compact form by bringing said side panels together, and
a threaded neck, which distends from the top of said collapsible container and which receives said threaded body of said closable nozzle in a leak-proof fashion, said threaded neck further comprising:
a neck opening for transferring fluid into said collapsible container during filling and for expelling said fluid from said collapsible container through said closable nozzle in a pressurized manner when said collapsible container is filled and squeezed; and
a support frame, said support frame comprising:
a rounded rectangular frame that fits over said collapsible container, said rounded rectangular frame having a top opening, which allows said threaded neck to distend through it when said support frame is fitted over said collapsible container.

4. An apparatus of claim 3, further comprising handles that distend from said side panels.

5. An apparatus of claim 3, further comprising a restraining strap, said restraining strap comprising: a resilient stretchable band, which may stretch over said support frame said when said collapsible container is expanded, and which functions to restrain said collapsible container in a compact manner when said collapsible container is collapsed.

6. An apparatus of claim 3, wherein said side panels are rounded-rectangular-shaped.

7. An apparatus of claim 3, wherein said side panels are ellipse-shaped.
